(19) United States
(12) Patent Application Publication
(10) Pub. No.: US 2011/0042521 A1
(43) Pub. Date: Feb. 24, 2011

(54) Spacecraft Launch and Exploration System

(76) Inventor: Daniel S. Sample, Los Angeles, CA (US)

Correspondence Address: Daniel Sterling Sample, 1773 N. Sycamore Ave., Apt. 5, Los Angeles, CA, 90028, US

(21) Appl. No.: 12/619,683

(22) Filed: Nov. 17, 2009

Related U.S. Application Data
(60) Provisional application No. 61/199,422, filed on Nov. 18, 2008.

(51) Int. Cl. B64G 1/14

(52) U.S. Cl. 244/159.3

(57) ABSTRACT

This invention is a launch-to-space, refuel and return system which comprises: a unique circular and straight maglev track and maglev sled spacecraft launcher; a single stage-to-LEO spacecraft (Mother Spacecraft); an orbiting space platform (OSP); a currently utilized Space Shuttle is altered to improve its safety, range, longevity and versatility which serves as a prototype for the Mother Spacecraft design. The Mother Spacecraft is releasably attached to the maglev sled and propulsion for the maglev sled is supplied by magnetic propulsion and on-board rocket propulsion. The collapsible OSP can fit into the Space Shuttle storage bay and is remotely deployed. The OSP is a refueling depot for the Mother Spacecraft, the Space Shuttle, as well as a rendezvous point for various space missions. A single, liquid, non-cryogenic rocket fuel is standardized throughout the entire system which eliminates: all vertical launches; all expendables; all solid rocket propellants.

### CROSS-REFERENCE TO RELATED APPLICATIONS

This application claims the priority date of Provisional Patent Application 61/199,422 filed on Nov. 18, 2008 and of Disclosure Document 609821 filed on Dec. 5, 2006 and of Disclosure Document 611357 filed on Jan. 23, 2007.

### FEDERALLY SPONSORED RESEARCH

Not applicable.

### SEQUENCE LISTING, ETC ON CD

Not applicable.

### BACKGROUND OF THE INVENTION

1. Field of the Invention

This invention relates to spacecraft and spacecraft launch systems and refueling spacecraft in space.

2. Description of Related Art

Our inability to define exactly what our objectives in space exploration should be has led to a limitless duplicity of goals, redundant space hardware, dead end space programs and a constant reevaluation of what we are doing in space. Costs have spiraled out of control on many of these systems including the Space Shuttle and the International Space Station. One flight on the Space Shuttle can exceed $1 billion dollars, a system that has lost much of its purpose in space due to a lack of understanding the very versatile capabilities of the Space Shuttle and cancellations from both the military and private companies.

The Constellation Program, with limited objectives, is poorly designed because it requires the designing and building of two new rockets from the ground up. It is a repetitious and backward looking effort which will do little to advance our knowledge of manned exploration of space and does even less to advance the safety factor. Solid propellant rocket engines and vertical launches remain as very dangerous and uncontrollable factors in launching manned spacecraft to Earth orbit.

Despite being flown into space since 1981, very little has been done to improve the basic safety or the costs of operating the Space Shuttle, particularly in the launch and reentry phases. What little change has come about was the result of two failed missions. Escalating costs of manned and unmanned space exploration require that our objectives in space be more clearly defined and combined, thus eliminating parallel, duplicate space programs. The Space Shuttle is a well designed and versatile spacecraft that can and should be used in future manned space exploration with specific alterations, including those changes made in this invention. Although originally designed for one hundred missions each, the Space Shuttle's life, safety and range of operation can be extended with certain modifications.

Fuel has been a major hurdle to manned space exploration and most of the designs for future rocket engines remain on the drawing board. Little has been done to create ways to utilize the technology and rocket systems that are already in use to assist in manned space exploration.

### BRIEF SUMMARY OF THE INVENTION

This invention is designed for maximum flexibility and safety while reducing costs to serve many objectives in space for many years to come. The four major components of the invention are the Maglev Launching System, the Mother Spacecraft, the Orbiting Space Platform and an upgrading and reconfiguring of the Space Shuttle. Versatility, cost reduction and the incorporation of our present space hardware are the keys to this system's success.

A single, non-solid, non-cryogenic, two part liquid rocket fuel, such as those in the hypergolic class, is standardized throughout this invention which will make the overall system much safer and allow for extended storage periods of the rocket fuel in space. Standardizing the fuel will also greatly reduce the costs of powering all space systems, both manned and unmanned.

The Maglev Launching System is comprised of a maglev track and a magnetically levitated, guided and propelled maglev sled upon which various configurations of spacecraft are propelled to a maximum velocity before separating from the maglev sled. Propulsion for the maglev sled is provided by three sources: magnetic propulsion; propulsion from the maglev sled's attached rocket motors; propulsion from the at least one rocket motor of the spacecraft to be launched from the maglev sled.

The elevated maglev track is constructed of concrete and reinforced with steel bars or other non-conductive composite material that will not interfere with the magnetic field of the maglev system.

The maglev sled is constructed of solid core, machined milled aluminum and titanium alloy framing. The maglev sled incorporates four externally mounted rocket motors, two backward facing and two forward facing, which provide forward thrust and reverse thrust to the maglev sled as needed. A rocket fuel supply system for the four maglev sled rocket motors is built into the maglev sled and is pressurized by helium. This same pressurized system also supplies the two part rocket fuel to all spacecraft on-board the maglev sled prior to spacecraft separation. This procedure insures that all spacecraft will have one hundred percent fuel mass on board at separation from the maglev sled.

The starboard (right) rocket motor housing is mounted externally on the maglev sled and extends below the maglev sled frame. This starboard rocket motor housing also contains a pressurized tank for the propellant portion of the two part rocket fuel. The port (left) rocket motor housing contains a pressurized tank for the oxidizer portion of the two part rocket fuel. The propellant and oxidizer are stored separately for safety reasons and a cross feed network installed in the maglev sled supply rocket fuel to all on-board rocket motors.

The Mother Spacecraft is a single stage spacecraft, much of its basic architecture and construction derived from an altered Space Shuttle prototype and is specifically designed to be launched from the maglev launcher. It is capable of reaching low earth orbit (LEO) when launched from the maglev launcher and can land at any landing strip of sufficient length and strength in the world. The landing gear of the Mother Spacecraft is of sufficient strength to permit the take off and landing of suborbital flights from selected airstrips without the aid of the maglev launcher. The Mother Spacecraft utilizes multiple bulkheads which are machined milled from aluminum and titanium alloy.

Launched horizontally from the maglev launcher, the Mother Spacecraft is aerodynamically designed to provide lift in the earth's sensible atmosphere prior to total reliance on rocket power for altitude and velocity. Vertical aerodynamic stabilization and control, centralized on the Space Shuttle, is moved to the wing tips of the Mother Spacecraft. This will permit a wide variety of spacecraft and fuel tank configurations to be “piggybacked” aboard the Mother Spacecraft, including the Space Shuttle. External mounts for external loads are centralized in selected bulkheads of the Mother Spacecraft.

The Mother Spacecraft is capable of sustained missions in deep space, including manned missions to the moon and Mars and beyond. The standardized two part rocket fuel can be stored both internally and externally on the Mother Spacecraft by way of easily transferable fuel tanks. Fuel tanks can also be transferred to the Mother Spacecraft from Orbiting Space Platforms (OSP) in orbit around the earth, the moon and Mars. One embodiment of the Mother Spacecraft incorporates ion plasma thrusters which, in unison with the two part liquid fueled rockets, will dramatically reduce interplanetary travel times. Reentry into the earth's atmosphere will be facilitated by at least two forward facing retro-rockets mounted near the rear of the Mother Spacecraft and above the wings which will substantially reduce air friction and heat. Prior testing to this embodiment will be done on the altered Space Shuttle prototype.

The Orbiting Space Platform (OSP) is unmanned and placed in orbit around the earth, the moon and Mars. The primary function of the OSP is to serve as a refueling depot for various spacecraft, including the Mother Spacecraft and the Space Shuttle, but will also serve as a platform for servicing satellites, as a rendevous point for reconfiguring various missions in space and as a storage facility for the International Space Station (ISS).

The OSP is simple in design and low cost in construction, constructed primarily of machine milled aluminum and titanium alloy. The OSP can be remotely operated from earth mission control, the moon's surface, Martian surface, the ISS or from any manned spacecraft on location. Electrical power is provided by twin solar arrays and batteries housed in the central axis of the OSP. Attitude control is provided by a series of gyroscopes. Directional and altitude control is provided by ion thrusters which are powered by the solar array and battery system. A television and lidar (laser)) system provide operational information and control for the remote human operator. The OSP is collapsible and can be placed in orbit and deployed from the storage bay of the Space Shuttle or the Mother Spacecraft or remotely deployed from an unmanned rocket.

The Space Shuttle remains as a key component of space exploration and its safety, range and versatility will be improved through selected upgrading and reconfiguring. The Space Shuttle serves as a working prototype for the Mother Spacecraft. One or more forward facing retro-rockets will be installed in the rear of the Space Shuttle's fuselage and above the wings to facilitate reentry into the earth's atmosphere, greatly reducing atmospheric friction and heat. The three main engines of the Space Shuttle are converted from oxygen-hydrogen fuel to the standardized two part rocket fuel of the entire space system. The current vertical launch system of the Space Shuttle is abandoned once the Maglev Launching System and Mother Spacecraft are in operation. One or more of the current Space Shuttles will have its range extended by the placement of fuel tanks in the present storage bay area, enabling the Space Shuttle crew to service satellites in geosynchronous orbit and/or remain in space for greatly extended time periods. External mounts are installed on the Space Shuttle for fuel tanks or providing transportation for material in space. One embodiment of the Space Shuttle utilizes it as a means of transporting the lunar landing craft from earth orbit to the moon's orbit, then serving as a command module in orbit for lunar landers.

Some known objectives which this invention addresses are: manning and servicing the International Space Station; folding in the Constellation Program to return to the moon; increasing the safety, range and longevity of the Space Shuttle and providing an alternative horizontal launching method for the Space Shuttle; building and launching a Mother Spacecraft capable of complimenting all of these objectives in space and serving as the centerpiece for manned missions to the moon, to Mars and beyond.

Standardization of a rocket propellant, including monomethyl hydrazine (MMH) with the oxidizer nitrogen tetroxide (N2O4) are preferred and do not require extreme temperature or high pressure for containment and can be stored in space for extended periods. This invention eliminates vertical launching of most manned and unmanned spacecraft, instead employing a horizontal launching method while enabling launched vehicles to reach a maximum velocity with one hundred percent fuel mass on-board at lift off.

This invention utilizes low cost, collapsing, unmanned, orbiting space platforms (OSB) that are placed in orbit around the earth, the moon and Mars to serve many objectives in space for decades to come, including: in-space refueling of the Space Shuttle and the Mother Spacecraft for extended space missions and powered reentry into the earth's atmosphere; a docking platform for configuring various space missions to the moon and Mars; a platform for repairing and refueling satellites and other spacecraft; servicing the International Space Station; a permanent storage facility for a future asteroid and comet deflection system. Surplus moth balled rockets, both liquid and solid rocket engine propelled, are used to place unmanned payloads of supplies, including rocket fuel, in low earth orbit for storage on these Orbiting Space Platforms.

Significantly lower cost, high flexibility, utilization of current space hardware and improved safety in space are the primary objectives of this invention which could serve the manned and unmanned exploration of space for decades to come.

### BRIEF DESCRIPTION OF THE SEVERAL VIEWS OF THE DRAWINGS

FIG. 1A Maglev Track Perspective

FIG. 2A Top View of the Maglev Track Supports and Maglev Track

FIG. 2B Front View of the Maglev Track Supports and Maglev Track

FIG. 2C End View of Maglev Track Supports and Maglev Track

FIG. 3A Maglev Track Overhead View

FIG. 3B Maglev Track Perspective View

FIG. 4A Maglev Sled Perspective

FIG. 5A Maglev Sled, Right Side (Starboard) View

FIG. 6A Maglev Sled, Top View

FIG. 7A Maglev Sled, Bottom View

FIG. 8A Maglev Sled, Front View

FIG. 8B Maglev Sled, Front View, Sled at dead stop, Wheels engaged with Maglev Track and supporting Maglev Sled

FIG. 8C Maglev Sled, Front View, Sled in motion, Wheels disengaged with Maglev Track

FIG. 9A Maglev Sled Wheel, Exploded View

FIG. 10A Maglev Sled Fuel Routing Diagram

FIG. 11A Maglev Sled, Right Side (Starboard) with Spacecraft Positioning

FIG. 12A Top View, Mother Spacecraft, Shuttle, Maglev Sled and Track

FIG. 13A Perspective View, Orbiting Space Platform, Mother Spacecraft, Shuttle, orbiting Mars

FIG. 14A Maglev Sled Front, Mother Spacecraft, Shuttle

FIG. 15A Mother Spacecraft Cut Away with Robotic Arms

FIG. 15B Mother Spacecraft Cut Away with External Tank

FIG. 16A Orbiting Space Platform, Side View

FIG. 16B Orbiting Space Platform, Bottom View

FIG. 16C Orbiting Space Platform, Collapsed for Storage and Transport

FIG. 16D Orbiting Space Platform, Perspective View in Operation in Orbit

FIG. 17A Space Shuttle, Top View with Fuel Tanks and Spine installed in Storage Bay

FIG. 17B Space Shuttle Fuel Tanks in Storage Bay, End View

FIG. 17C Exploded Side View, Fuel Tank, Spine, Space Shuttle

FIG. 17D Rear End View of Space Shuttle, Direction of Retro-Rocket Thrust

FIG. 17E Top View of Space Shuttle, Direction of Retro-Rocket Thrust

FIG. 17F Side View of Space Shuttle with External Pod Attached Below Shuttle

FIG. 17G Rear End of Space Shuttle with External Pod Attached Below Shuttle

It should, of course, be understood, that the drawings herein are merely illustrative and it will be apparent that the various modifications, combinations and changes can be made of the structures and the systems disclosed without departing from the spirit of the invention and from the scope of the appended claims.

### DETAILED DESCRIPTION OF THE INVENTION

This invention centers around apparatus that are engineered to work together to form a comprehensive method of horizontally launching a spacecraft to low earth orbit, refueling said spacecraft in space, then returning said spacecraft to earth. They are the maglev launching system, the Mother Spacecraft; unmanned, multi-use, Orbiting Space Platforms (OSP); alterations to the existing Space Shuttle.

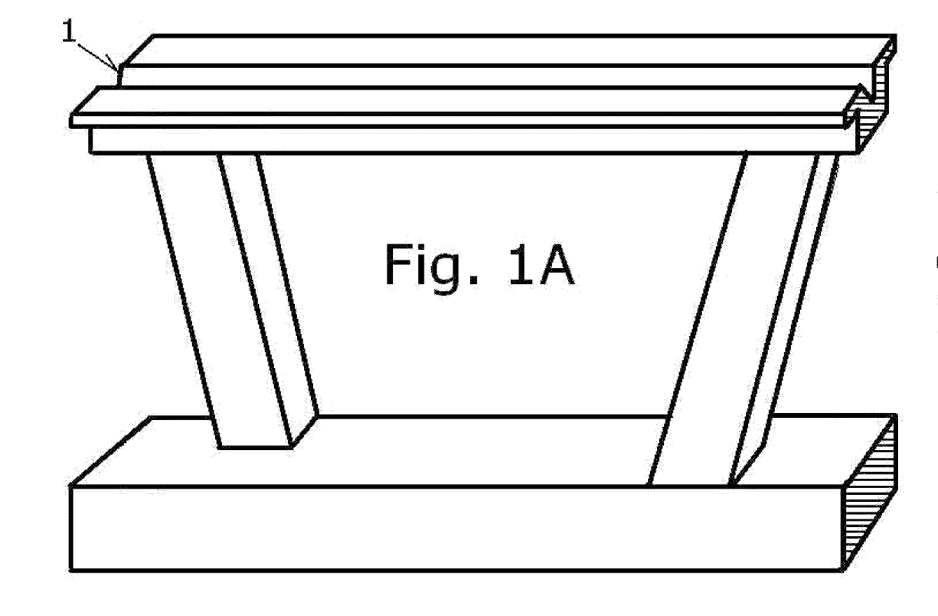

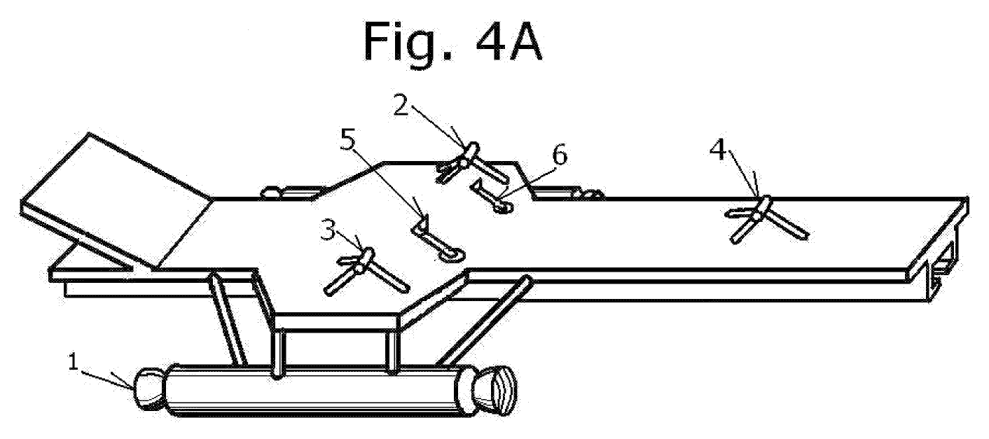

The first part of the invention is the maglev launching system which elevates and propels a maglev sled FIG. 4A along an elevated magnetic levitation track FIG. 1A. The maglev sled is magnetically levitated above the maglev track, guided magnetically and propelled by both magnetic force and by at least one attached rocket motor 4A 1. Additional propulsion is provided by at least one rocket motor of the spacecraft to be launched.

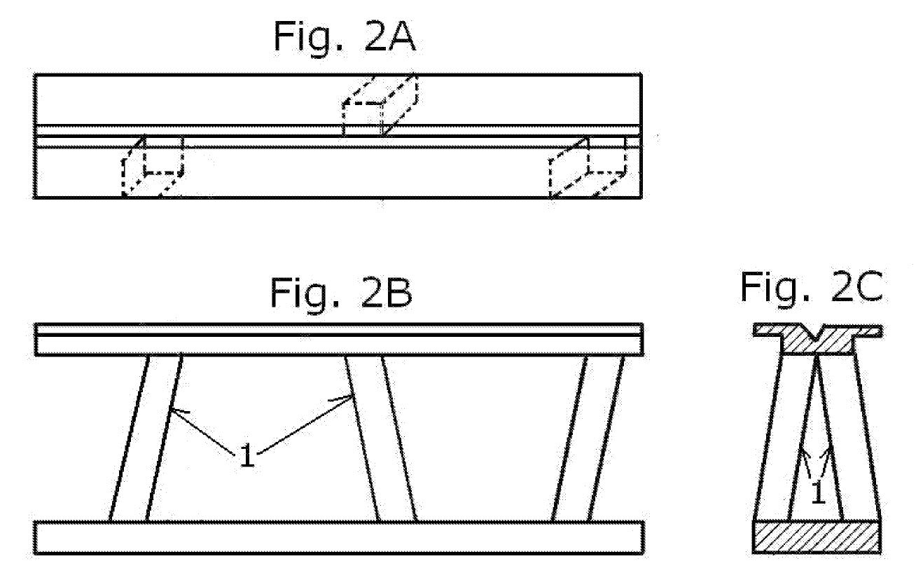

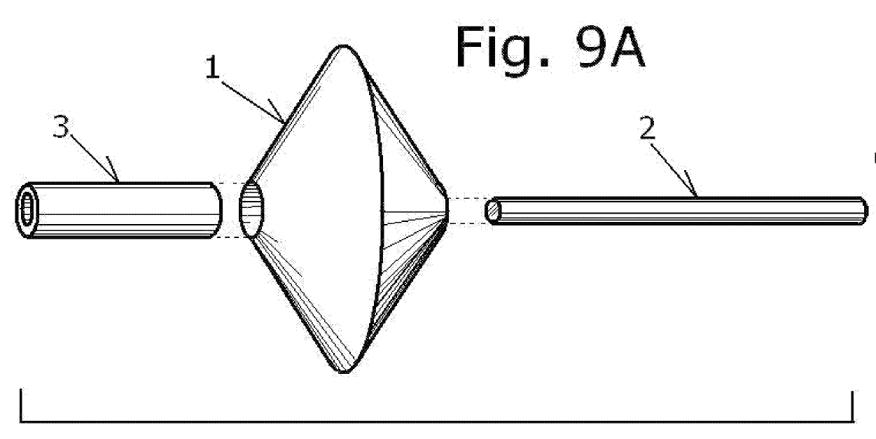

The elevated maglev track is constructed of reinforced vertical concrete supports which are constructed at alternating dihedral angles in the vertical plane FIG. 2B 1 and in alternating opposing angles in the horizontal plane FIG. 2C 1 to put maximum weight bearing strength beneath the maglev track while providing maximum lateral support to the maglev track. There is a V shaped cut FIG. 1A 1 through the middle of the concrete track to accommodate the V shaped wheels FIG. 9B 1 of the maglev sled.

Wheels are necessary for the inductrack I method of levitating the maglev launching sled that is demonstrated in this embodiment. Other embodiments might utilize other methods of levitation which are possible, employing superconductors, positive or repulsive methods of levitation which may not require wheels to operate the system.

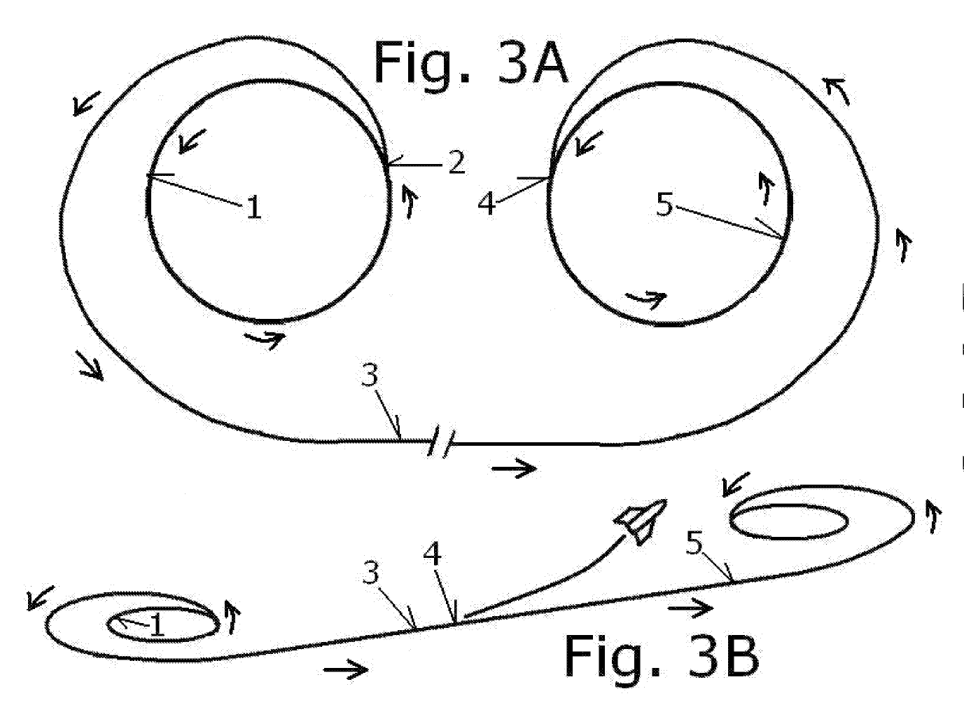

The maglev track of this embodiment is laid out in three distinct sections in FIG. 3A and FIG. 3B. The first section FIG. 3A 1 is a circular maglev track referred to as the run-up track which is constructed at the base of a bluff FIG. 3B 1. This circular run-up track is rolled slightly inward toward the center of the track. The maglev track switches (switching mechanism not shown) at FIG. 3A 2 to a spiraling track. The spiral track becomes a straight track referred to as the straight-away track at FIG. 3A 3. The straight-away track is the second section of the maglev track which is laid out on the side of a steep bluff FIG. 3B 3. The launch window occurs between FIG. 3B 4 and 5. At the top of the bluff, as the track levels out, the track returns to a spiral and rolls inward again slightly, then switches at FIG. 3A 4 to a circular track FIG. 3A 5 which is the third section of the maglev track referred to as the run-down track. Other embodiments of the maglev track may be completely straight maglev tracks; maglev tracks without a vertical inclination; maglev tracks which employ any combination of circular, straight, flat or vertically inclined embodiments.

The maglev sled travels along this maglev track, beginning from a dead stop and zero levitation on the run-up track FIG. 3A 1 and ending at a dead stop and zero levitation on the run-down track FIG. 3A 5. Space vehicles for launch are releasably attached at three points FIG. 4A 2,3,4 to the top of the sled by quick release mechanisms (not shown in detail), including exploding bolts or rocket motors. When the sled and the space vehicle pass through the launch window the space vehicle is released from the maglev sled and becomes airborne.

The maglev launching system can utilize a number of different magnetic levitation, magnetic guidance and magnetic propulsion configurations. The presently preferred embodiment described here (not shown in detail on the drawings) employs the inductrack I method of levitating the launch sled above the maglev track using unpowered loops of wire in the track and permanent magnets, arranged into Halbach arrays on the maglev sled. The loops of wire on the track are configured as a ladder track, made of unpowered Litz wire cables. The track is optimized to maximize lift force. The sled is stabilized in the lateral and yaw directions with feedback controlled lateral control coils that interact with the permanent magnet rails on the track. Vertical, pitch and roll motions can be controlled or damped with eddy-current damper coils or plates or with active feedback control to control the coils. Propulsion is achieved for the sled by a linear synchronous motor mounted on the track.

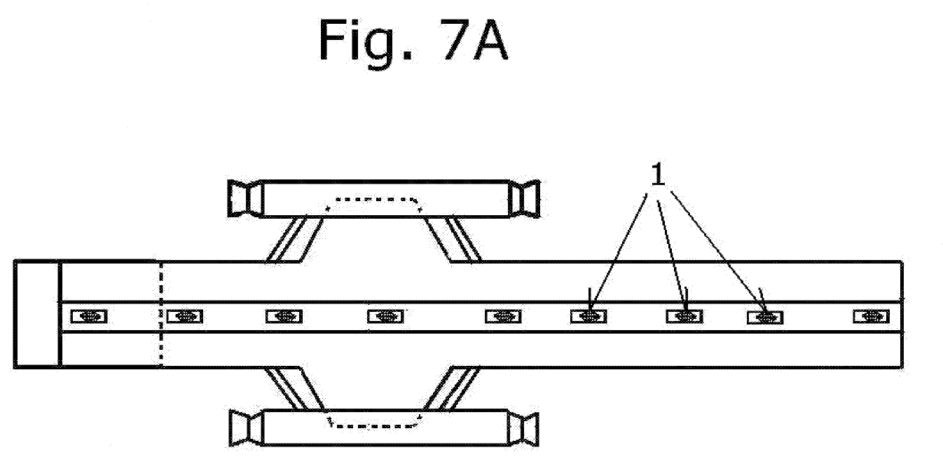

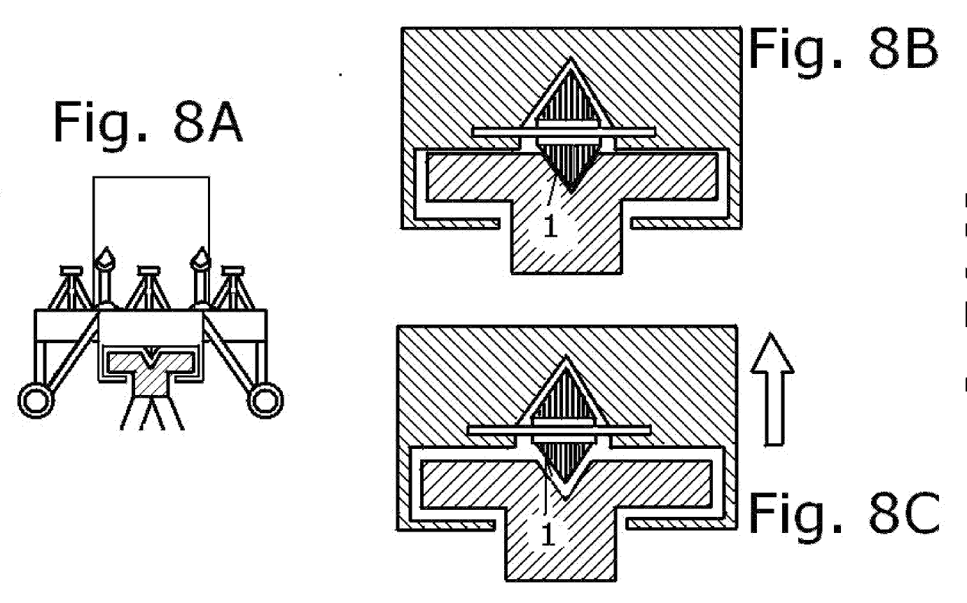

The maglev sled is supported at standstill FIG. 8B 1 by a least one row of V shaped solid core rubber or composite wheels FIG. 7A 1 and FIG. 9A 1 which work as “pseudo” levitation devices because levitation can only be achieved by the motion of the Halbach arrays on-board the sled, interacting with the coils on the track. Because the inductrack I method of levitation employed here is of the EDS Class, the maglev sled must be moving in order to be levitated. The sled is first propelled by a minimal thrust by one of the on-board rocket motors on the sled FIG. 4A 1 and is supported on the V shaped rubber or composite wheels until levitation occurs at a minimal speed. Magnetic levitation lifts the maglev sled and lifts the rubber or composite wheels out of the V groove FIG. 8C 1 and the wheels do not contact the track again until the sled slows down to a near-stop at the end of a launch run. The maglev wheel apparatus is composed of the solid core rubber or composite wheel FIG. 9A 1, the machine milled steel axis FIG. 9A 2 and the connector FIG. 9A 3 between the wheel and the axis which is composed of a low friction composite material or a ball bearing apparatus (details not shown).

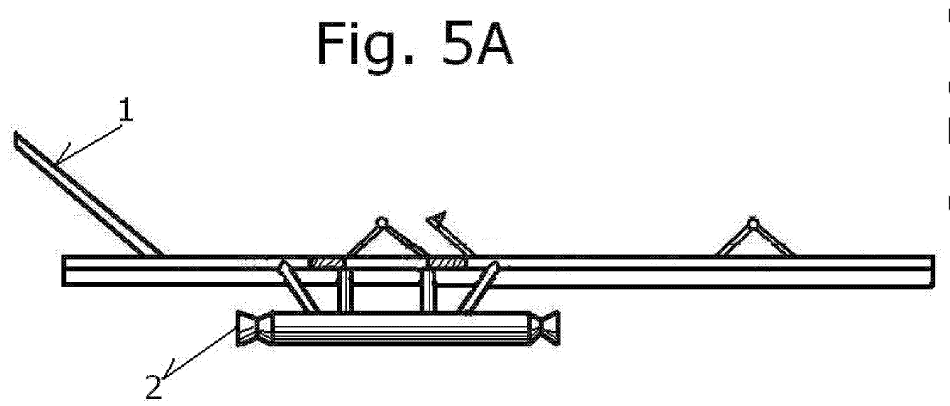

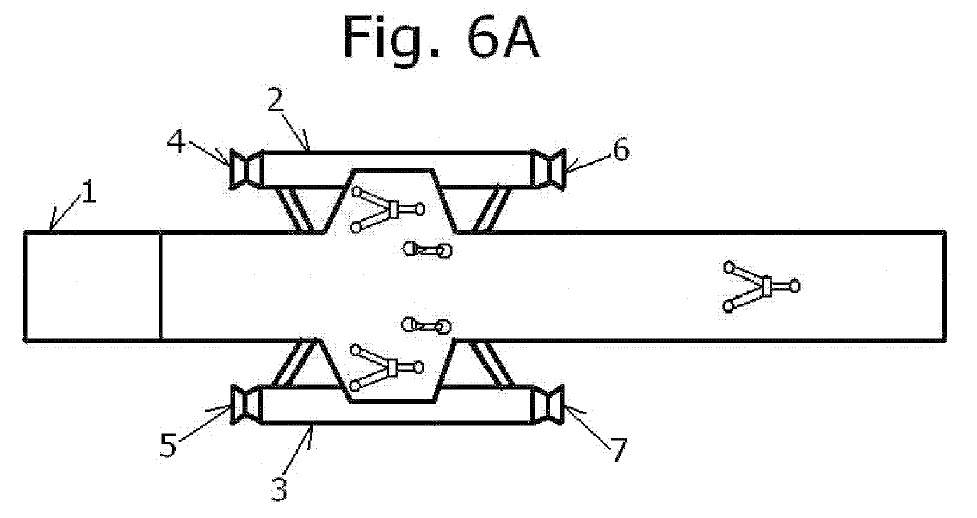

A heat blast shield FIG. 5A 1 and FIG. 6A 1 at the rear of the maglev sled protects the maglev track from the rocket exhausts from on-board space vehicles and the two rear-facing rocket motors on-board the maglev sled. There are two rocket pods FIG. 6A 2 and 3 on-board the maglev sled, each with one rear-facing rocket motor FIG. 6A 4 and 5 and each with one forward facing rocket motor (retro-rocket) FIG. 6A 6 and 7.

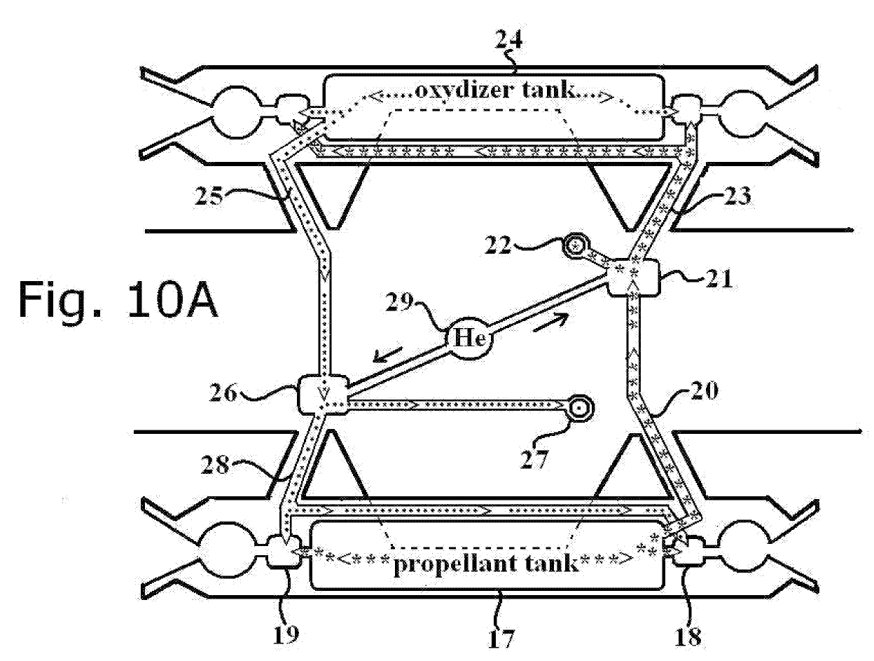

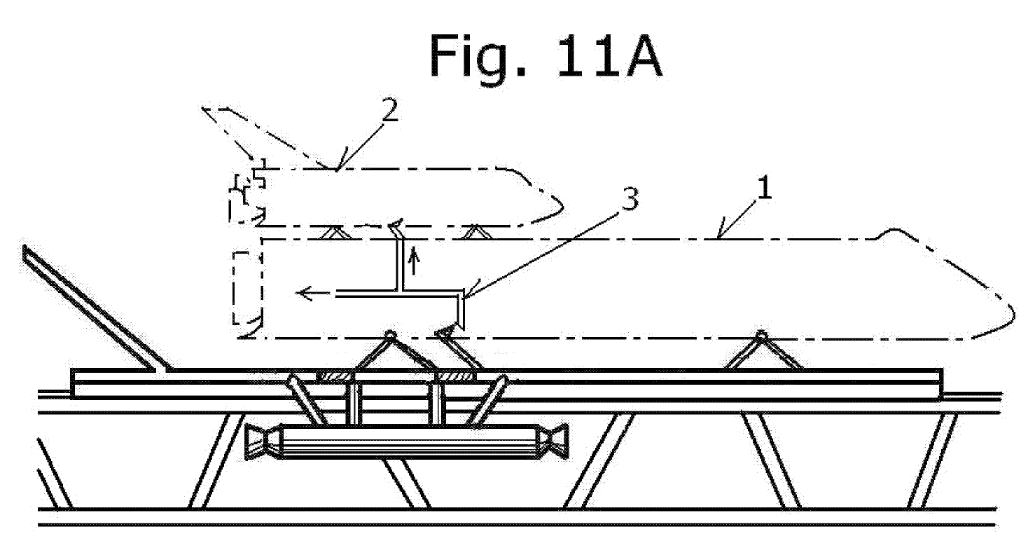

A top view cross section of the maglev sled FIG. 10A reveals the rocket propellant storage tank FIG. 10A 17 that provides rocket propellant to all four of the maglev sled rocket motors and all on-board spacecraft. Rocket propellant is fed directly from the right (starboard) storage tank to the two right (starboard) rocket motors FIG. 10A 18 and 19 and routed into the propellant line at FIG. 10A 20 to the helium pressurization tank (details not shown) at FIG. 10A 21. Propellant is routed to the two left (port) rocket motors through FIG. 10A 23. Propellant is also routed to onboard spacecraft at a releaseable hook-up at FIG. 10A 22. The oxidizer tank in the left (port) rocket pod FIG. 10A 24 feeds rocket oxidizer directly into the two rocket motors in the left (port) rocket pod. Oxidizer is routed FIG. 10A 25 to the helium pressurization tank (details not shown) at FIG. 10A 26. Oxidizer is routed to the two right (starboard) rocket motors FIG. 10A 28. Oxidizer Is also routed to on-board spacecraft at a releaseable hook-up at FIG. 10A 27. Rocket propellant and oxidizer are fed to all rocket powered spacecraft FIG. 11A 3 from the maglev sled fuel tanks to insure that all releaseably attached spacecraft are launched with one hundred percent fuel mass, even though the spacecraft rocket motors may be employed in the initial launch sequence.

Rocket propellant and oxidizer tanks are kept separated for safety reasons. The universal fuel in this embodiment and for all spacecraft in this invention and the maglev sled rocket motors, whenever possible for safety, stability, store-ability and controllability, is preferably, but not limited to, a two part hypergolic fuel. Another embodiment might employ hydrogen peroxide as the oxidizer and a petrol based propellant as rocket fuel for the entire system. A wide variety of manned and unmanned space vehicles can be launched from the maglev sled at very high velocities and at a very competitive cost per launch.

The maglev and rocket propelled launch system is designed to launch manned spacecraft at an acceleration that will never exceed three times the force of gravity (3G's). This can be accomplished by gradually increasing the velocity of the maglev sled on the circular run-up track utilizing magnetic propulsion, then adding rocket propulsion on the straight away track while maintaining a steady level of acceleration. Unmanned vehicles may be launched at several times the force of gravity.

Very importantly, launch sequences can be aborted before, during or after the launch window, a safety factor and a vast improvement over vertically launched spacecraft and launches which use solid fueled rocket motors. The maglev sled can be immediately slowed by reversing the maglev polarities on the maglev track and/or utilizing the two retro rockets on-board the maglev sled. Another embodiment of the braking system will utilize a parachute system to slow the maglev sled. Again, for manned missions, the force of negative gravity never exceeds three times gravity (3G's) as the sled is brought to a complete stop very gradually on the circular run-down track. The on-board wheels on the maglev sled slowly descend to the track as the maglev sled slows and the inductrack I magnetic field separating the maglev sled and the maglev track lessens to zero.

A typical maglev sled launch in this embodiment, is as follows: A manned Mother Spacecraft FIG. 11A 1 with a manned Space Shuttle FIG. 11A 2 mounted on top of the maglev sled begins at the circular run-up track FIG. 3A 1 at a stand still. The Mother Spacecraft, the attached Space Shuttle and the maglev sled are supported entirely on the maglev track by the sled wheels. The maglev track is rolled slightly inward toward the center of the circular track. A short thrust from the starboard rocket motor of the sled FIG. 5A 2 moves the maglev sled forward slowly. The inductrack I magnetic levitation takes effect and the sled is begins to elevate above the maglev track, and in so doing, the sled wheels are lifted off of the track FIG. 8C 1. The sled starboard rocket motor shuts down temporarily as magnetic levitation, propulsion and guidance increase as the speed of the maglev sled increases.

The acceleration of the maglev sled, because humans are on-board in this embodiment, is limited to a maximum of 3G's while a high velocity is gradually achieved on the circular track. The maglev sled, after reaching a maximum velocity attainable with magnetic propulsion, switches to a spiraling track at FIG. 3A 2. The maglev track begins to gradually roll back toward a level attitude as the maglev sled gains velocity through magnetic propulsion. The two rocket motors on-board the maglev sled are ignited as the track continues to roll toward a level attitude on the spiral track.

The rocket motors of the Mother Spacecraft and the Space Shuttle are ignited, adding to the thrust of the sled rocket motors and the magnetic propulsion as the track reaches a level roll attitude. The sled maintains a maximum acceleration of 3G's as the velocity increases. The sled enters the straight away track and begins a gradual rate of pitch upward FIG. 3B 3 following the contour of a bluff. When the maglev sled reaches the desired pitch angle and velocity for lift off and enters the launch window FIG. 3B 4 to 5, the spacecraft are released.

Just prior to spacecraft separation, the propellant line FIG. 4A 5 and oxidizer line FIG. 4A 6 on the maglev sled automatically detach from the Mother Spacecraft. The Mother Spacecraft, aerodynamically designed for lift, separates from the sled using fast release rocket motors or explosive bolts (details not shown).

The maglev sled continues to the top of the bluff and begins to pitch downward as it levels out and enters the second spiraling track. The two rear-facing rocket motors on the maglev sled are shut down and the two retro rocket motors on the sled are ignited, initiating a braking sequence. Maglev braking is initiated as the sled begins to roll inward as it nears the circular run-down track. The sled switches from the spiral track and to the circular run-down track at FIG. 3A 4. The sled continues to slow using retro rocket braking and reverse maglev braking on the circular run-down track. The magnetic levitation of the inductrack I field slowly collapses and the wheels of the sled re-engage with the V cut in the maglev track and the sled rolls to a complete stop, supported by the wheels FIG. 8B 1.

Safety is a key element of launching from the maglev sled because aborts can be accomplished at any point on the maglev track, including aborts after the sled and the attached spacecraft pass the launch window. The spacecraft can remain attached to the sled on late aborts and be brought to a safe stop on the run down track. A negative 3 G's is never exceeded when braking manned missions on aborts.

The Mother Spacecraft FIG. 11A 1 is designed specifically for launching from the maglev sled and will accomplish a wide range of missions in space, utilizing a number of various externally attached configurations, including the Space Shuttle as shown FIG. 11A 2. The Mother Spacecraft is designed and constructed of material closely resembling an updated and reconfigured Space Shuttle prototype. The Mother Spacecraft is designed for a wide variety of missions, from serving as a sub-orbital booster for the Space Shuttle, to extended manned missions to Mars and beyond.

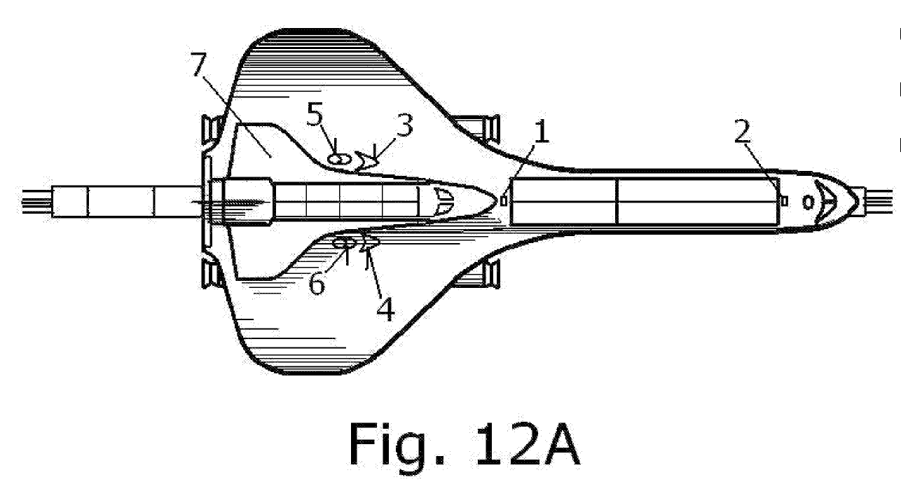

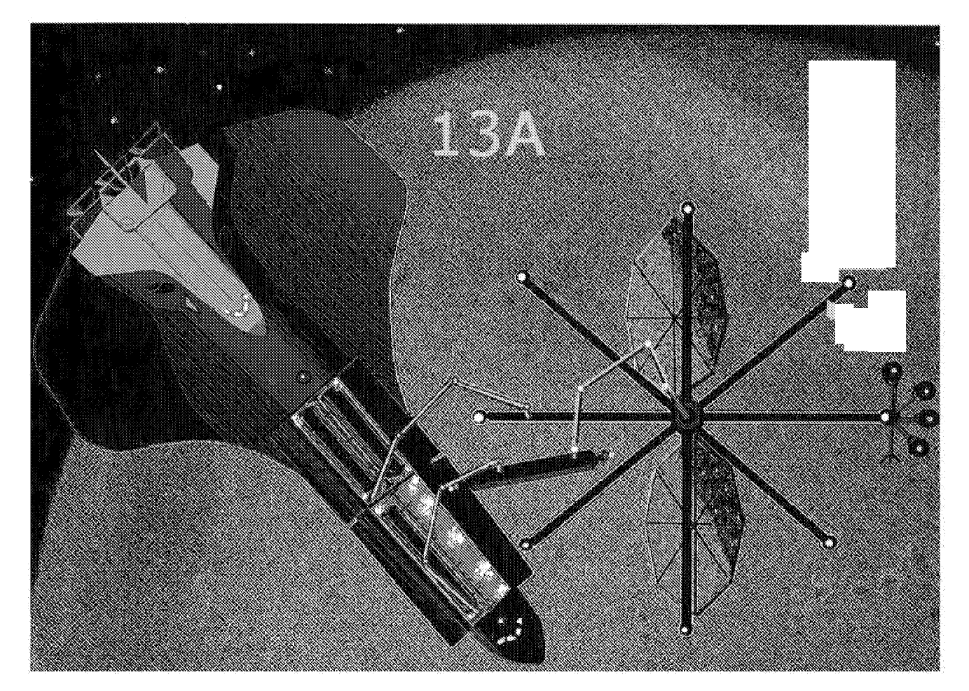

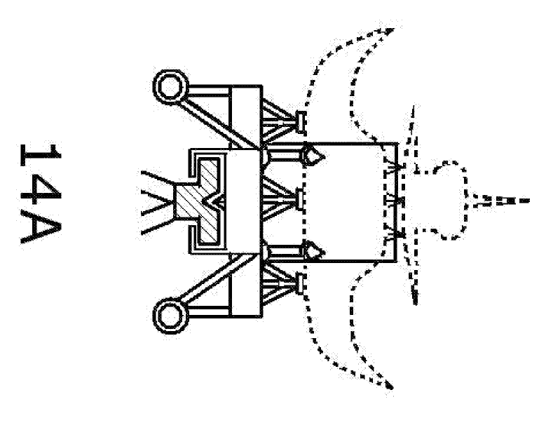

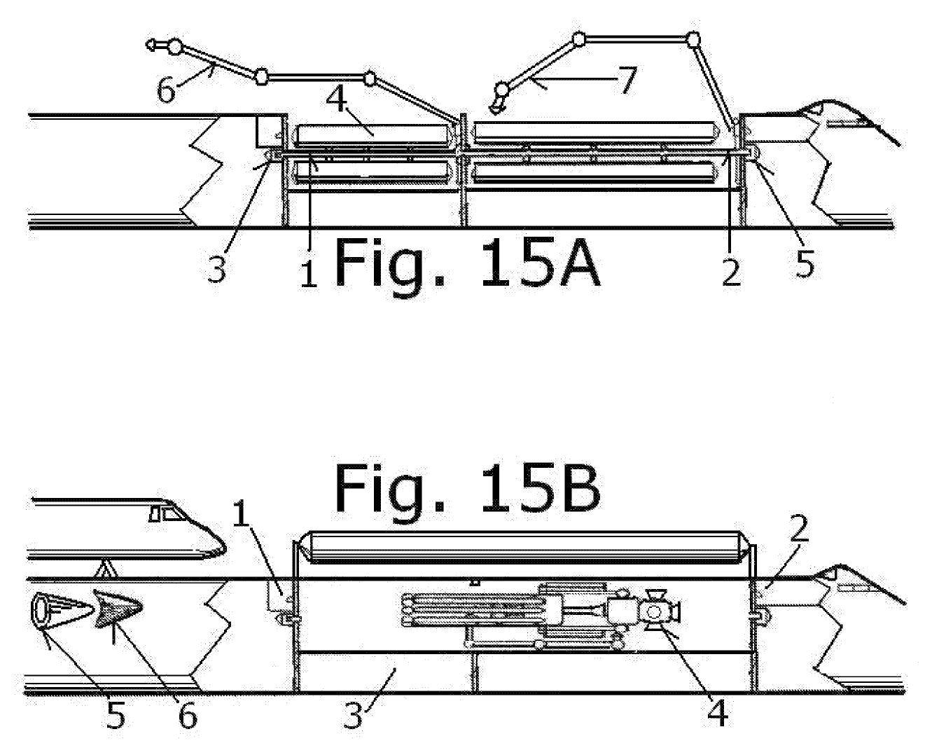

Externally, the Mother Spacecraft is fitted to carry a number of payloads into orbit, including the Space Shuttle and rocket fuel tanks. External payloads, including fuel tanks as shown in FIG. 15B can be attached to two connections located near the two storage bays. One connection FIG. 12A 1 in the aft bay bulkhead and one connection FIG. 12A 2 in the forward bay bulkhead are for external payloads.

The Mother Spacecraft has two manned control centers FIG. 15B 1 and FIG. 15B 2 to operate and visually monitor operations involving the storage bays. Access to the aft control center is made through a passage way beneath the storage bays FIG. 15B 3.

The two storage bays of the Mother Spacecraft each have a rotatable pole called the spine FIG. 15A 1 and FIG. 15A 2 running the length of each storage bay to which any number of various payloads can be attached. The aft bay spine can be rotated by an electric motor FIG. 15A 3 to facilitate loading and unloading different cargo configurations including, but not limited to, fuel tanks FIG. 15A 4, oxygen tanks, etc. The longer spine in the forward storage bay can also be rotated by an electric motor FIG. 15A 5. Both spines can be detached from their central location and stored at the bottom of the storage bay to accommodate larger payloads, such as a Orbiting Space Platform as shown in FIG. 15B 4.

Both storage bays each have a remotely controlled robotic arm FIG. 15A 6 and FIG. 15A 7 which are used to move payloads out of or into the two storage bays. One arm is used to grapple an object in space, such as the International Space Station or an orbiting space platform, while the other arm can performed other tasks, such as the movement of payloads in or out of either storage bay.

The Mother Spacecraft is designed attain low earth orbit with the assist of the maglev launcher or to serve as a suborbital booster to assist any number of spacecraft, including the Space Shuttle, into attaining low earth orbit. The Mother Spacecraft can enter a low earth orbit with the aid of rocket fuel stored in the storage bays and/or attached externally. Launching the Mother Spacecraft from the maglev sled can result in a very high release velocity, achieved by maglev propulsion, the two rocket motors attached to the maglev sled and rocket thrust from the Mother Spacecrafts' own rocket motors and, in some cases, from rocket motors aboard piggybacked space vehicles including the Space Shuttle.

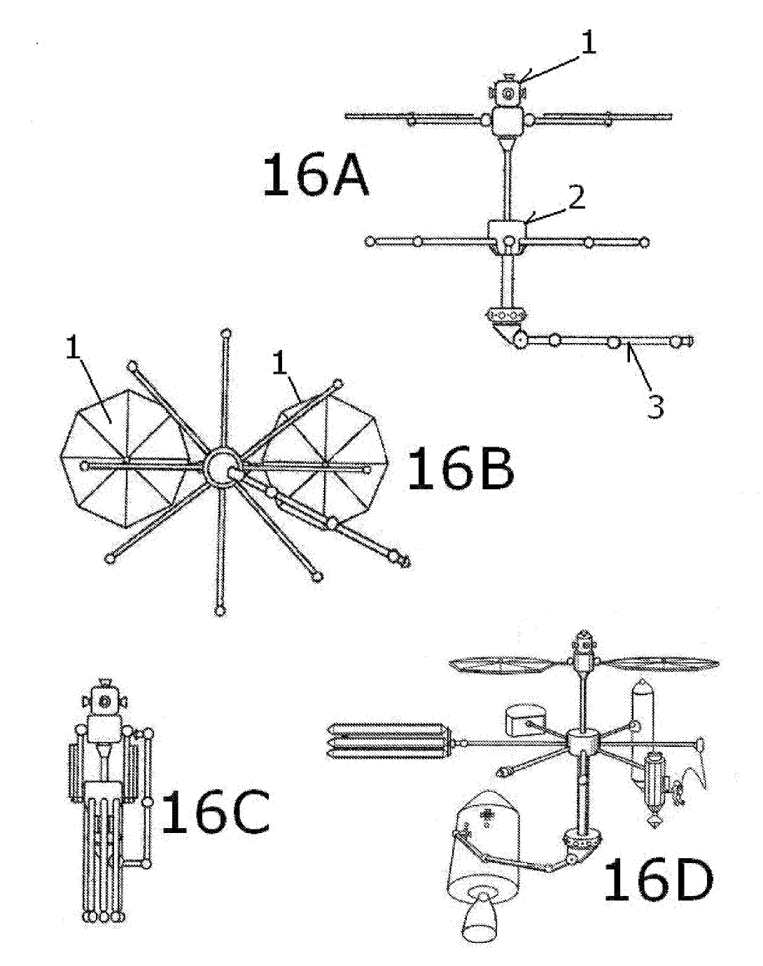

The Mother Spacecraft wings are designed to provide aerodynamic lift and control until the spacecraft rises above the sensible atmosphere. The Mother Spacecraft is designed for extended missions in deep space, including lunar and Mars missions. The Mother Spacecraft is designed for powered re-entry into the Earth's atmosphere, first refueling at the orbiting space platform FIG. 16D if necessary. After an extended de-orbiting reverse thrust from the main rocket motors, the Mother Spacecraft has at least two forward facing rockets (retro-rockets) FIG. 15B 5 and FIG. 12A 5,6 in which to enter the earth's atmosphere at a reduced speed and greatly reducing atmospheric friction and heat. The retro-rockets are strategically placed well behind the leading edge of the spacecraft wings for protection. The retro-rockets are recessed slightly and there is a deflection shield FIG. 15B 6 and FIG. 12A 4,5 to protect the retro-rockets from atmospheric friction and to protect the Mother Spacecraft from retro-rocket exhaust.

The orbiting space platform (OSP) FIG. 16D is placed in earth orbit, moon orbit and Mars orbit to facilitate missions in space. The orbiting space platform is simple in design, inexpensive, is carried into space in the storage bay of either the Space Shuttle or the Mother Spacecraft or by unmanned rockets. It will serve as a storage platform for many current and future missions in space.

The embodiment of the orbiting space platform (OSP) described herein is unmanned and contains eight legs FIG. 16B which are tipped with a universal connectors (details not shown) and a variety of other connectors which can be attached by the remote robotic arm. The OSP will hold and store a wide variety of objects in orbit, including rocket fuel containers. It will be placed in orbit at a safe distance from the International Space Station (ISS) and will be controlled remotely via radio transmission, television cameras and pulsed laser devices (LIDAR) from the Earth, from the ISS or from various manned space vehicles, including the Space Shuttle or the Mother Spacecraft.

The orbiting space station contains a microwave thrusting system FIG. 16A 1, powered by two solar arrays 16B 1 for minor orbiting and attitude corrections. Attitude control is also provided by a series of gyroscopes (not shown) installed in the central housing FIG. 16A 2. Major movements of the orbiting space platform will be achieved by attaching a remotely controlled rocket to one of the legs. It can also be moved by collapsing the orbiting space station and placing it in the storage bay of the Space Shuttle or the Mother Spacecraft for transportation to a new location. Another embodiment has a ion thruster installed on the OSB for periodic orbit corrections.

The orbiting space platform has at least one robotic arm FIG. 16A 3 which can be remotely controlled to attach or detach various materials to the eight legs. The robotic arm swivels for 360 degrees and the tip of the arm is a universal connector with a pulsed laser transmitter (LIDAR) and television camera (details not shown) to facilitate remote operations.

The orbiting space station serves as a staging point for configuring any number of missions in space, including lunar missions, Mars missions and, in another embodiment, an OSP is placed in geosynchronous earth orbit for satellite work by the Space Shuttle. Principally, the OSP it will serve as a refueling depot for different spacecraft, including the Space Shuttle and the Mother Spacecraft. The orbiting space platform (OSP) will also serve as a storage point for spare parts and waste material for the ISS. It will also serve as a long term storage point for a device (not shown) to alter the path of objects such as asteroids or comets that threaten to collide with the Earth. Unmanned surplus rockets, to reduce costs, are used to supply the orbiting space platform with material for space missions with special attention for storage of liquid rocket fuel tanks and other liquid gases, including oxygen, helium and nitrogen.

This invention involves refurbishing and reconfiguring the Space Shuttle for safety, longevity, range and versatility in space. This altered Space Shuttle will also serve as a working prototype for designing the Mother Spacecraft and will be launched into low earth orbit “piggybacked” on-board the Mother Spacecraft.

Uniformity and singularity of a universal rocket fuel for this invention is achieved by converting the three main engines of the Space Shuttle from liquid hydrogen/liquid oxygen fuel to a two-part liquid fuel that is more stable, and requires less temperature and pressurization extremes and can be stored for longer periods in space without degeneration. One embodiment employs rocket fuels in the hypergolic class while another embodiment utilizes hydrogen peroxide and petroleum based fuels.

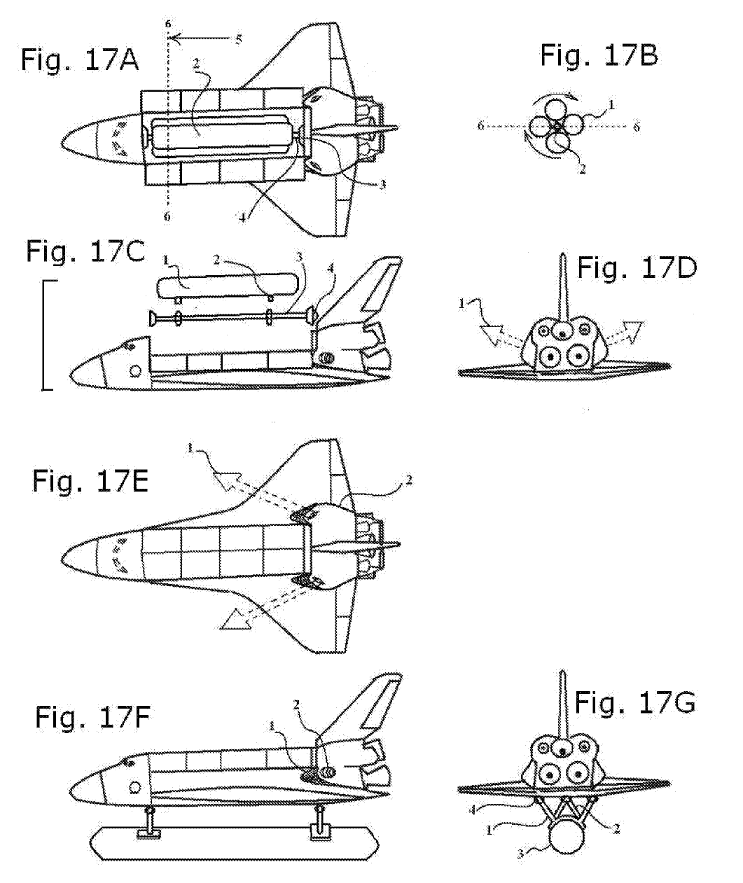

The storage bay of at least one Space Shuttle is altered to accommodate fuel tanks FIGS. 17A and 17C. A centrally located storage bay spine FIG. 17A 4 and FIG. 17B 2 and 17C 3 can accommodate several fuel tanks FIG. 17A 2 and FIG. 17B 1 and FIG. 17C 1. The spine can be rotated FIG. 17B 2 by way of the storage spine motor located at FIG. 17A 3 and FIG. 17C 4 to facilitate extracting or adding fuel tanks to the storage bay. A line-of-sight cross section FIG. 17A 6 and FIG. 17B 6 of four fuel tanks mounted on the rotating spine is illustrated with the direction of sight shown at FIG. 17A 5. Adding a spine like that in the Mother Spacecraft FIG. 15A 1,2 will greatly increase the Space Shuttle's range and versatility and allow the Space Shuttle to reenter the Earth's atmosphere in a powered mode to greatly reduce atmospheric friction and heat. The Space Shuttle serves as a prototype for the later Mother Spacecraft in this instance, again illustrating the importance of extending the life of the Space Shuttle.

The Space Shuttle will be adapted to ride piggyback atop the Mother Spacecraft FIG. 12A 7 using the current attachments employed to attach the Space Shuttle to the current external fuel tank. Fuel lines will be installed between the Mother Spacecraft and the Space Shuttle FIG. 11A 3 to permit the Space Shuttle's three main rocket engines to assist in launches and still be launched with one hundred percent fuel mass on-board. The Space Shuttle in another embodiment can be altered to allow crew egress between the Space Shuttle and the Mother Spacecraft. A dual flight control system is installed in both spacecraft to permit either spacecraft to operate the entire configuration, another safety feature (not shown).

External attachments, such as moon landers, fuel tanks, supply pods, etc. can be added to the Space Shuttle, either above the storage bay or to the nose section of the Space Shuttle or below the Space Shuttle, FIG. 17G 3 utilizing existing external fuel tank connections FIG. 17G 4 and FIG. 17G 1, 2.

Two forward facing and recessed retro rockets will be installed above and behind the leading edge of the Space Shuttle's wings FIG. 17F 2 to greatly reduce atmospheric friction during de-orbiting. The sides of the existing Space Shuttle are flared outward FIG. 17E 2 to permit room for the installation of the two retro-rockets in the existing framework. The general direction of the retro-rockets thrust is indicated at FIG. 17D 1 and FIG. 17E 1. These alterations will serve as a prototype for the installation of retro-rockets in the Mother Spacecraft, underlining the importance of extending the life of the Space Shuttle. The two retro-rockets, upon reentry into the atmosphere, are shielded from atmospheric friction by deflectors FIG. 17F 1 composed of carbon-carbon or newer material employed by the X-37 which also shields the Space Shuttle exterior from exhausts from the retro-rockets.

The apparatus of this invention, the maglev launcher, the Mother Spacecraft, the orbiting space platform and alterations to the Space Shuttle work together to provide a safe, flexible and very cost effective means of providing support to many current and future missions in space, known and unknown. The maglev launching system will be employed for many different spacecraft configurations for generations to come, serving as a first stage for most manned and unmanned spacecraft. The cost of research and development of the Mother Spacecraft will be minimal since much of it is based on the basic architecture of the current Space Shuttle. Another cost effective approach is the universal usage of a stable two part rocket fuel system, including those in the hypergolic class of rocket propellants or hydrogen peroxide/petroleum based fuel. Extending the range of the Space Shuttle means the spacecraft can stay in space for extended periods, docked at the ISS or the Orbiting Space Platform, reducing the number of expensive and dangerous launches. The newly reconfigured Space Shuttle will perform many tasks in space that would otherwise require the construction of many different spacecraft, including the servicing and repair of satellites in geosynchronous orbit, serving as a command module for lunar missions and complimenting deep space missions to Mars.

The foregoing description of the preferred embodiments of the invention has been presented for purposes of illustration and description. It is not intended to be exhaustive or to limit the invention to the precise form disclosed, and many modifications and variations are possible in light of the above teaching without deviating from the spirit and the scope of the invention. The embodiment described is selected to best explain the principles of the invention and its practical application to thereby enable others skilled in the art to best utilize the invention in various embodiments and with various modifications as suited to the particular purpose contemplated. It is intended that the scope of the invention be defined by the claims appended hereto.

The invention claimed is:

1. A means and apparatus for a spacecraft launch and exploration system which comprises:
a number of improvements to a currently employed Space Shuttle; and
a single stage spacecraft (Mother Spacecraft) designed and constructed to be launched from a maglev sled, utilizing said Space Shuttle as a working prototype; and
a maglev track and maglev sled system for launching said single stage spacecraft to LEO; and
a multipurpose, collapsible, Orbiting Space Platform (OSP) for refueling said spacecraft and said Space Shuttle in space.

2. The structure of said Space Shuttle in claim 1, wherein said improvements comprise:

3. at least one retro-rocket motor and carbon carbon shield installed in the aft portion of said Space Shuttle; and

4. a rotatable, electric motor driven, removable rack spine installed in said Space Shuttle storage bay; and

5. multiple external storage mounts installed on said Space Shuttle.

6. The structure of said single stage spacecraft (Mother Spacecraft) in claim 1, wherein said Mother Spacecraft construction comprises:

7. at least one retro-rocket motor and carbon carbon shield installed in the aft section of said Mother Spacecraft; and

8. a rotatable, electric motor driven, removable rack spine installed in each storage bay of said Mother Spacecraft; and

9. multiple external mounts installed on said Mother Spacecraft to accommodate said Space Shuttle and external fuel tanks; and

10. The structure of said maglev track and said maglev sled system in claim 1, wherein said maglev track and said maglev sled construction comprise:

11. said maglev sled with at least one rear facing rocket motor and at least one forward facing (retro-rocket) motor installed on said maglev sled; and

12. a refueling system installed in said maglev sled to insure 100 percent full fuel mass on all spacecraft releaseably attached to said maglev sled at lift off.

13. a circular maglev track where said maglev sled is levitated, propelled and guided to a maximum velocity possible utilizing magnetic propulsion only; and

14. said maglev sled switches from said circular maglev track to a spiral maglev track that transitions into a vertically inclined, straight maglev track where said maglev sled achieves maximum velocity by magnetic propulsion, propulsion by at least one rocket motor installed in said maglev sled and propulsion by at least one rocket motor of said Mother Spacecraft which is released from said maglev sled as it passes through a launch window; and

15. said maglev sled passes the launch window and a braking sequence begins with at least one said maglev sled retro-rocket motor igniting and reverse magnetic propulsion is employed to slow said maglev sled as it transitions to a spiral rack and switches to a second circular track where said maglev sled is brought to a complete stop.

16. The structure of said Orbiting Space Platform (OSP) in claim 1, wherein said OSP construction comprises:

17. a collapsing frame for easy storage in the storage bay of said Space Shuttle and said Mother Spacecraft; and

18. a least one robotic arm, remotely controlled by LIDAR and television monitoring, and at least one fixed arm for moving rocket fuel tanks and other material to and from said OSP; and

19. an electric ion thruster powered by at least one solar array for minor orbital corrections.
